(19) United States
(12) Patent Application Publication
(10) Pub. No.: US 2014/0254853 A1
(43) Pub. Date: Sep. 11, 2014

(54) Music listening and playing apparatus

(71) Applicants: Gregory Blonder, Summit, NJ (US); Au Sze Keung, Chai Wan (HK)

(72) Inventors: Gregory Blonder, Summit, NJ (US); Au Sze Keung, Chai Wan (HK)

(21) Appl. No.: 13/815,538

(22) Filed: Mar. 8, 2013

(51) Int. Cl. H04R 1/10

(52) U.S. Cl. CPC H04R 1/1066
USPC 381/371

(57) ABSTRACT

A headset apparatus is provided, the apparatus comprises: a headband; at least two connectors, each of the connectors has at least two arms, a first arm being shorter than a second arm; and at least two speakers, each speaker comprising an audio output element on a first side, each of the audio output elements of each of the speakers face one another during a first music listening mode, and each of the audio output elements of the speakers are designed to be rotated away from one another during a second music playing mode, the rotation causing the change in modes.

### BACKGROUND OF THE INVENTION

1. Field of the Invention

This invention relates to a music listening and playing apparatus and more specifically, music headphones with rotating speakers and with music listening and playing modes.

2. Description of the Related Art

There are various patents covering headphones and headsets. The present invention provides for a headset that can be used as a music listening device and can convert into a music playing device.

### SUMMARY OF THE INVENTION

In one embodiment, the present invention provides for a music playing and listening apparatus comprising: a headband having opposing ends; at least two connectors, each of the connectors having at least two arms, a first arm is shorter than a second arm; and at least two speakers, each of the speakers having opposing sides and comprising an audio output element on a first side and a compartment on a second side, the first and second arms of each of the connectors is pivotally attached to a portion of each of the speakers to thereby allow rotation of the speakers, each of the audio output elements of each of the speakers generally face one another during a first music listening mode, each of the speakers being rotatable about the first and second arms of each of the connectors to thereby allow each of the audio output elements of each of the speakers to turn away from one another during a second music playing mode; the rotation of the speakers allowing for changes in modes.

In another embodiment, the length ratio of the first arm to the second arm of each of the connectors is from about 1:1.1 to about 1:10. In yet another embodiment, the length ratio of the first arm to the second arm of each of the connectors is from about 1:1.25 to about 1:5.

In still another embodiment, each of the speakers rotates about an axis formed by the first and second arms of each of the connectors. In still yet another embodiment, each of the speakers is designed to rotate about the axes during the first music listening mode at angles from about 0 degrees to about 100 degrees. In a further embodiment, each of the speakers is designed to rotate about the axes during the first music listening mode at angles from about 0 degrees to about 30 degrees. In another further embodiment, each of the speakers is designed to rotate about the axes during the second music playing mode at angles from about 20 degrees to greater than 180 degrees. In yet another further embodiment, the speakers are designed to rotate about the axes during the second music playing mode at angles from about 30 degrees to about 180 degrees.

In still another further embodiment, the headband is generally situated over a user's head and each of the audio output elements of each of the speakers generally faces the user's ears during the first music listening mode.

In still yet another further embodiment, the apparatus is situated around a user's neck and both of the speakers are designed to be rotated and allow each of the audio output elements of each of the speakers to generally face away from the user during the second music playing mode.

In another embodiment, the apparatus is set on a surface and the headband is generally parallel to the surface and the speakers are designed to be rotated about the first and second arms of each of the connectors to allow the audio output elements of each of the speaker to generally face away from the surface during the second music playing mode.

In yet another embodiment, the length of the second arm relative to the first arm creates an angle between the surface and at least one speaker, and the angle is greater than 1 degree and less than 90 degrees.

In still another embodiment, the length of the second arm relative to the first arm creates an angle between the surface and at least one speaker, and the angle is from about 10 degrees to about 80 degrees.

In still yet another embodiment, each of the connectors comprises a third arm rotatably attached to opposing ends of the headband.

In a further embodiment, the apparatus further comprises a safety interlocking device which is designed to limit the volume output of the speakers in the first listening mode and increases the volume output of the speakers during the second music playing mode.

In yet a further embodiment, the speakers lock into place during the second music playing mode.

In still a further embodiment, the apparatus further comprises at least two ear cushions, each of the cushions is attached to at least a portion of the audio output element.

In still yet a further embodiment, the apparatus further comprises at least one amplifier, and the amplifier is connected to a portion of at least one of the speakers.

In another further embodiment, the apparatus further comprises at least one switching mechanism, and the switching mechanism is activated by rotating each of the speakers from said music listening mode to the second music playing mode, and the rotation of the speakers activates the amplifier.

In yet another further embodiment, the apparatus further comprises at least one switching mechanism, and the switching mechanism is activated by rotating one of the speakers from the music playing mode to the second music listening mode, and the rotation of one of the speakers deactivates the amplifier.

In still another further embodiment, at least one of the compartments of the speakers provides for storage of a power source. In still yet another further embodiment, the headband provides for storage of a power source. In another embodiment, the apparatus further comprises at least one power source, and the power source is a battery.

In yet another embodiment, the apparatus further comprises an on and off mechanism. In still another embodiment, the apparatus further comprises volume control mechanism, and the volume control mechanism controls audio output volume of the speakers. In yet another embodiment, the apparatus further comprises a cable and an adaptor. In still yet another embodiment, the headband is generally U shaped.

In a further embodiment, the apparatus further comprises a wireless receiver designed to accept audio signals from an external source.

In yet a further embodiment, the present invention relates to a music playing and listening apparatus comprising: a headband having opposing ends; at least two connectors, each of the connectors having at least two arms, a first arm is shorter than a second arm; at least two speakers, each of the speakers having opposing sides and comprising an audio output element on a first side and a compartment on a second side, the first and second arms of each of the connectors is pivotally attached to a portion of each of the speakers to thereby allow rotation of the speakers, each of the audio output elements of each of the speakers generally face one another during a first music listening mode, each of the speakers is designed to be rotated to thereby allow each of the audio output elements of each of the speakers to turn away from one another during a second music playing mode; and a safety interlocking device designed to limit the volume output of the speakers in the first listening mode and increases the volume output of said speakers during said second music playing mode.

In still a further embodiment, each of the speakers rotates about an axis formed by the first and second arms of each of the connectors, each of the speakers is designed to rotate about the axis during the first music listening mode at angles from about 0 degrees to about 100 degrees.

In still yet a further embodiment, each of the speakers rotate about an axis formed by the first and second arms of each of the connectors, wherein each of the speakers is designed to rotate about the axis during the second music playing mode at angles from about 20 degrees to greater than 180 degrees.

In another embodiment, the present invention provides for a music playing and listening apparatus comprising: a headband having opposing ends; at least two connectors, each of the connectors has at least two arms, a first arm is shorter than a second arm, and the first and second arms has a length ratio of from about 1:1.1 to about 1:10; and at least two speakers, each of the speakers having opposing sides and comprising an audio output element on a first side, the first and second arms of each of the connectors is pivotally attached to a portion of each of the speakers to thereby allow rotation of the speakers, each of the audio output elements of each of the speakers generally face one another during a first music listening mode, each of the speakers is designed to be rotated to thereby allow each of the audio output elements of each of the speakers to turn away from one another during a second music playing mode.

### BRIEF DESCRIPTION OF THE DRAWINGS

The accompanying drawings are included to provide a further understanding of the present invention. These drawings are incorporated in and constitute a part of this specification, illustrate one or more embodiments of the present invention and together with the description, serve to explain the principles of the present invention.

FIG. 1 is a perspective view of the apparatus of the present invention in a music listening mode on a user's head;

FIG. 2 is a perspective view of the apparatus of FIG. 1 in a music playing mode around a user's neck;

FIG. 3 is a perspective view of the apparatus of FIG. 1 in a music playing mode when the apparatus is place on a surface;

FIG. 4a-c are perspective side view of the apparatus showing the rotation of the speakers; and

FIG. 5a-b are views of the apparatus showing the angles created by the rotation;

FIG. 6 is view of the apparatus in FIG. 3 showing how the differing length of the arms create angles between the speaker and the surface; and

FIG. 7a-b are schematic view of one of the embodiments of the switch mechanism.

Among those benefits and improvements that have been disclosed, other objects and advantages of this invention will become apparent from the following description taken in conjunction with the accompanying drawings. The drawings constitute a part of this specification and include exemplary embodiments of the present invention and illustrate various objects and features thereof.

### DETAILED DESCRIPTION OF THE INVENTION

As required, detailed embodiments of the present invention are disclosed herein; however, it is to be understood that the disclosed embodiments are merely exemplary of the invention that may be embodied in various forms. The figures are not necessarily to scale, some features may be exaggerated to show details of particular components. Therefore, specific structural and functional details disclosed herein are not to be interpreted as limiting, but merely as a basis for the claims and as a representative basis for teaching one skilled in the art to variously employ the present invention.

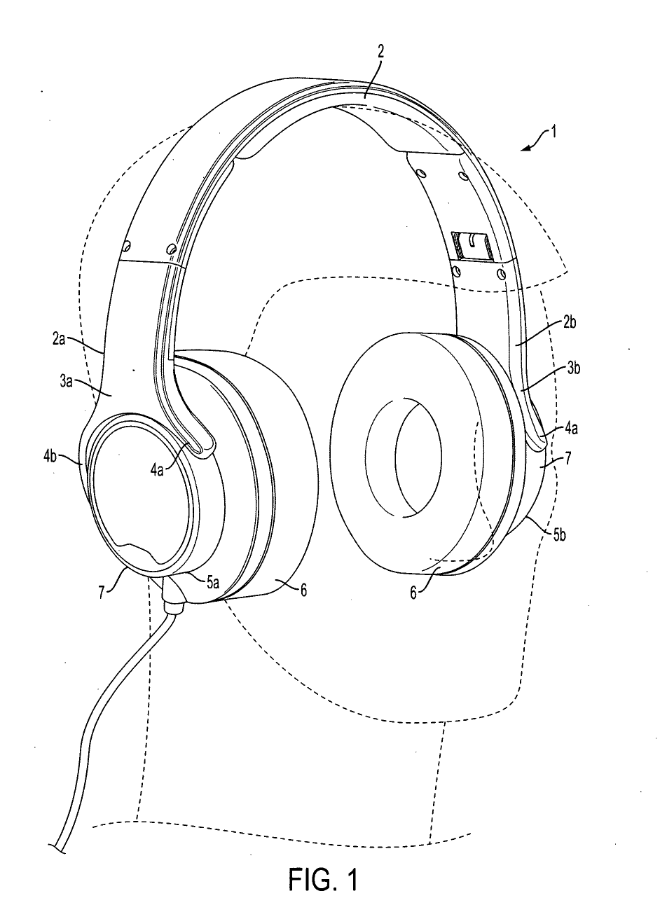

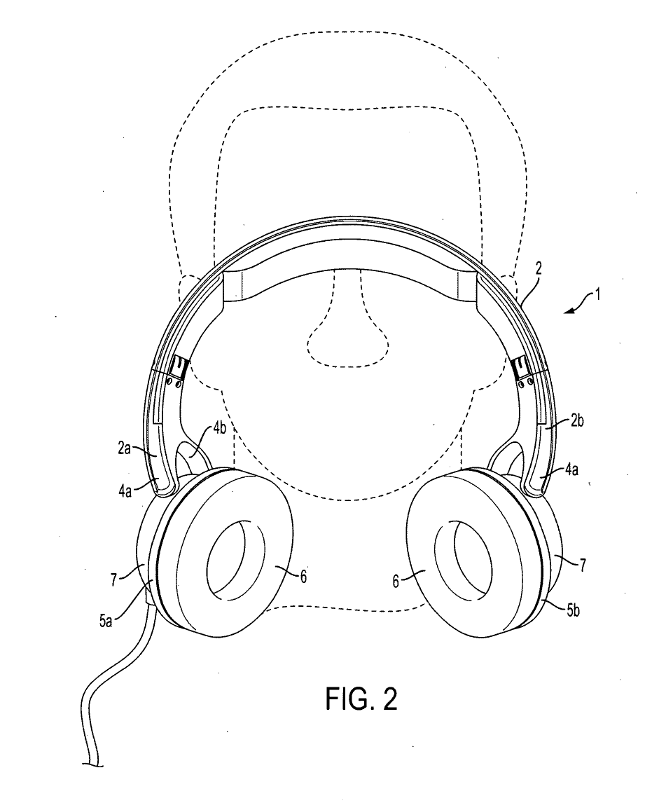

FIG. 1 illustrates the music listening and playing apparatus 1 of the present invention. The apparatus comprises a headband 2 having opposing ends, 2a and 2b respectively; at least two connectors, 3a and 3b respectively, each of the connectors has at least two arms, 4a and 4b respectively. The first arm 4a is shorter than a second arm 4b.

The apparatus 1 further comprises at least two speakers, 5a and 5b respectively, each of the speakers having opposing sides and comprising an audio output element 6 on a first side and a compartment 7 on a second side. The first and second arms, 4a and 4b, of each of the connectors is pivotally attached to a portion of each of the speakers, 5a or 5b, to thereby allow rotation of said speakers. Each of the audio output elements 6 of each of the speakers, 5a and 5b, generally face one another during a first music listening mode. In the music listening mode, the headband 2 is situated around the user's head and the audio output element 6 of each of the speakers, 5a and 5b, are generally facing the user's ears.

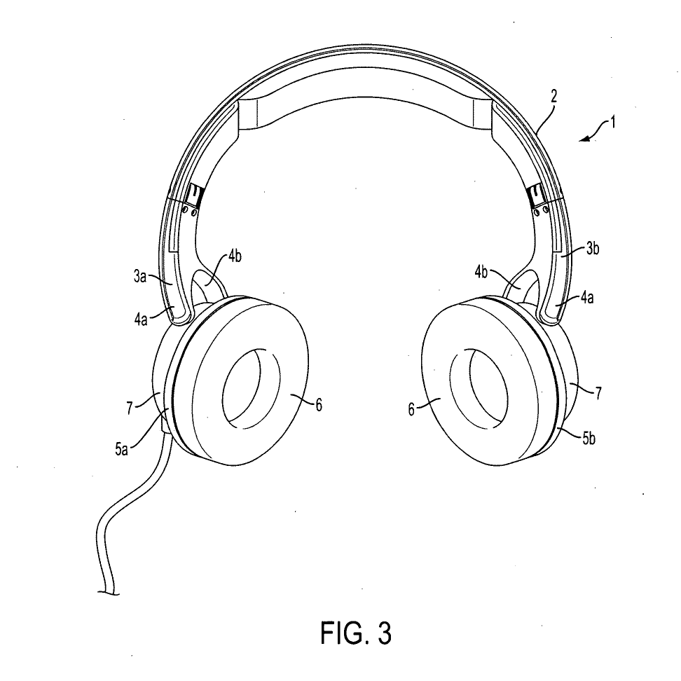

FIG. 2 depicts the second music playing mode of the apparatus 1 of the present invention. The apparatus 1 may be placed around the user's neck. Each of the speakers, 5a and 5b, are rotatable about the first and second arms, 4a and 4b, of each of the connectors, 3a and 3b, to thereby allow each of the audio output elements 6 of each of the speakers, 5a and 5b, to turn away from one another during the second music playing mode. The rotation of the speakers, 5a and 5b, allows for changes in modes.

FIG. 3 shows another music playing mode where the apparatus 1 is set on a surface and the headband 2 is generally parallel to the surface 10 and the speakers, 5a and 5b, are designed to be rotated about the first and second arms, 4a and 4b, of each of the connectors, 3a and 3b, to allow the audio output elements 6 of each of the speakers, 5a and 5b, to generally face away from the surface 10 during the second music playing mode.

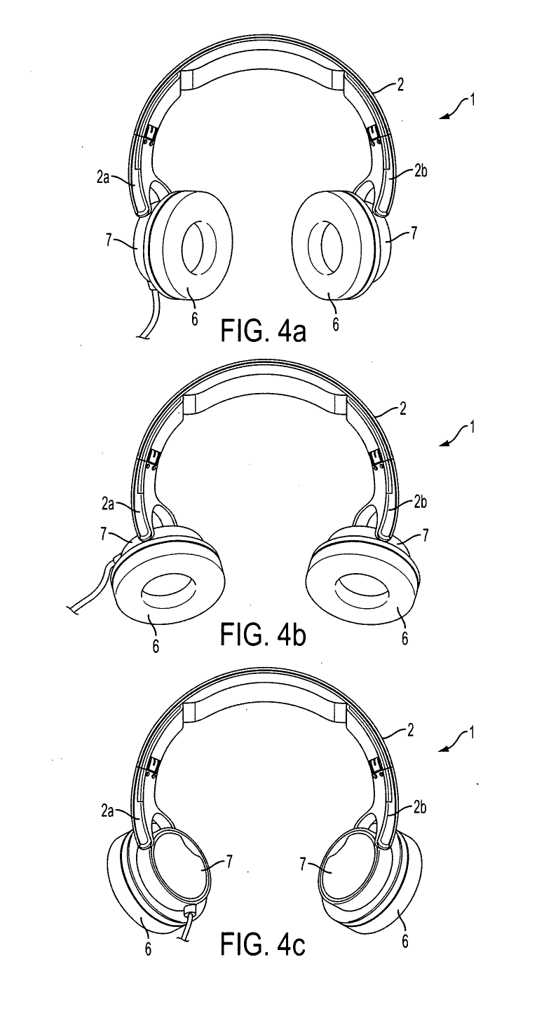

FIGS. 4a-c illustrates the rotation of the speaker, 5a and 5b. During the music listening mode, the audio output element 6 of the speaker 5a is generally facing inward as shown in FIG. 4a. The speaker 5a is rotated outwardly to activate the music playing mode as shown in FIG. 4b. In the music playing mode, the speaker 5a may be adjusted for optimum sound as shown in FIG. 4c. The speaker 5 may then be rotated back to its original position as shown in FIG. 4a to return to the music listening mode.

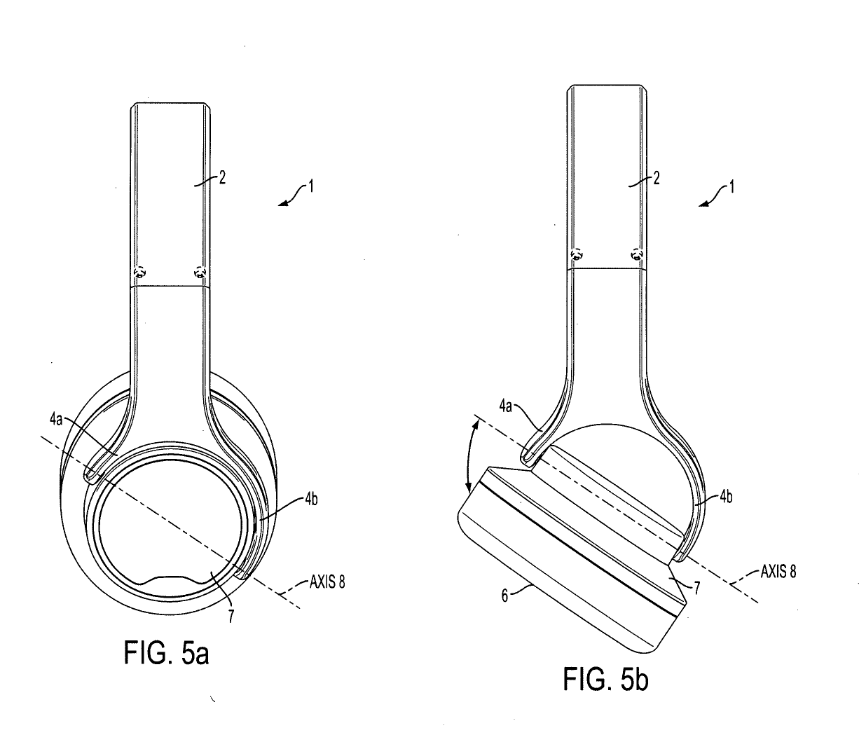

Each of the speakers, 5a and 5b, rotates about an axis 8 formed by the first and second arms, 4a and 4b, of each of the connectors, 3a and 3b. Each of the speakers, 5a and 5b, is designed to rotate about the axis 8 during the first music listening mode at angles from about 0 degrees to about 100 degrees as shown in FIG. 5a.

Each of the speakers, 5a and 5b, is designed to rotate about the axis 8 during the second music playing mode at angles from about 20 degrees to greater than 180 degrees as shown in FIG. 5b.

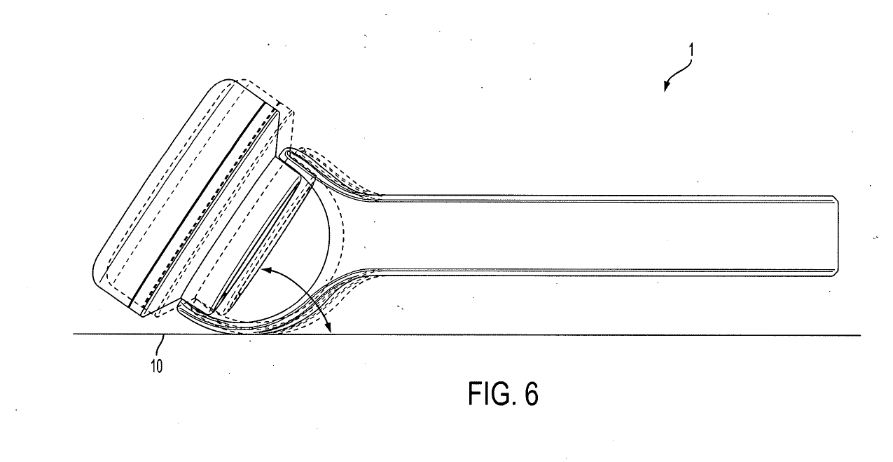

FIG. 6 shows that differing the length ratios of the arms, 4a and 4b, create different angles between the speaker 5a and surface 10. The length of the second arm 4b relative to the first arm 4a creates an angle between the surface 10 and at least one speaker 5, and the angle is greater than 1 degree and less than 90 degrees.

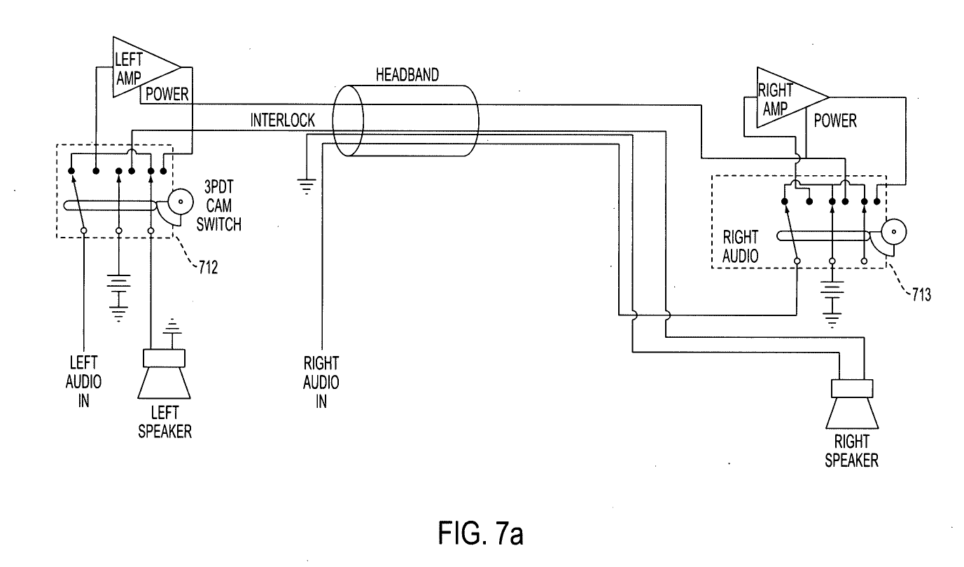

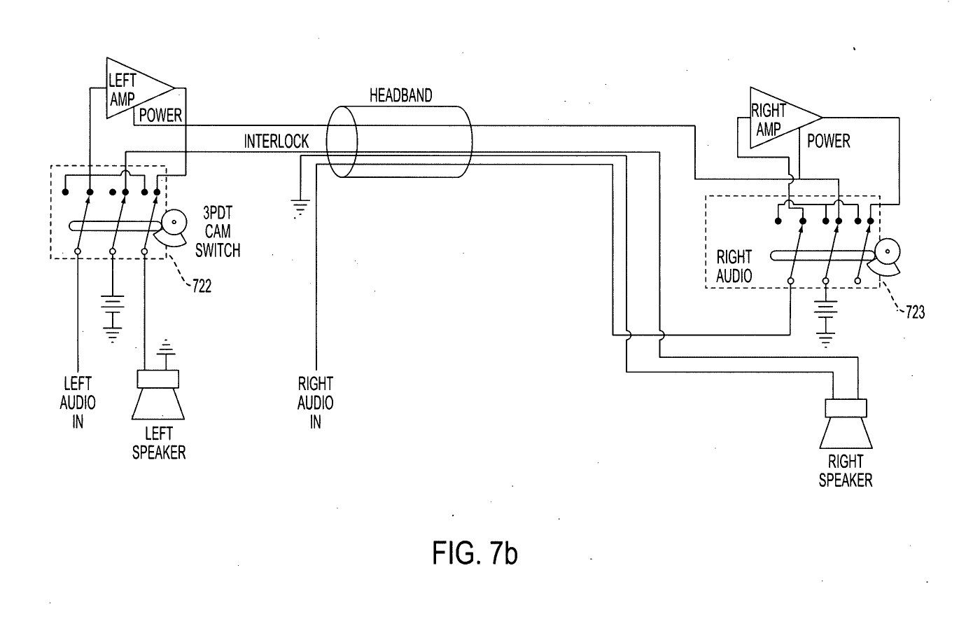

FIG. 7a-b are schematic diagrams of one of the embodiments of the circuitry of the present invention. In this embodiment, the cam switch 712 (shown schematically) has three contacts on the input, and six on the output (a three pole double throw switch-3PDT).

When the axle is not rotated and the product is worn as a headset, the switch connects the left audio channel directly to the left speaker, and the right audio channel to the right speaker, and does not route power to the amplifier. The music device powers the acoustic transducer directly. However, once the enclosures are rotated by more than 30 degrees, the two 3PDT switches 722 and 723 are thrown closed. This now routes the left audio signal to the left amplifier and the output of the left amplifier to the left speaker (and similarly for the right channel). It also provides power to the amplifier by running the power through the right enclosure switch in series-thus assuring both switches must be closed (and thus the speakers aimed safely away from the ears) before energizing the amplifier.

There are other variations and embodiments of the circuit. In another embodiment, the switch could contain one input and one output, used to trigger a solid state relay that provides all the aforementioned audio and power routing. In a further embodiment, the switch might be used to control the volume level, so it is low as a headset and high as a speaker. This invention can be used with any applicable circuitry and is not limited to the circuitry shown in FIG. 7.

Numerous modifications and variations of the present invention are possible in light of the above teachings. It is therefore to be understood that within the scope of the attendant claims attached hereto, this invention may be practiced otherwise than as specifically disclosed herein.

What is claimed is:

1. A music playing and listening apparatus comprising:
a headband having opposing ends;
at least two connectors, each of said connectors having at least two arms, a first arm being shorter than a second arm; and
at least two speakers, each of said speakers having opposing sides and comprising an audio output element on a first side and a compartment on a second side, said first and second arms of each of said connectors being pivotally attached to a portion of each of said speakers to thereby allow rotation of said speakers, each of said audio output elements of each of said speakers generally face one another during a first music listening mode, each of said speakers being rotatable about said first and second arms of each of said connectors to thereby allow each of said audio output elements of each of said speakers to turn away from one another during a second music playing mode; the rotation of said speakers allowing for changes in modes.

2. The apparatus of claim 1 wherein the length ratio of said first arm to said second arm of each of said connectors is from about 1:1.1 to about 1:10.

3. The apparatus of claim 1 wherein the length ratio of said first arm to said second arm of each of said connectors is from about 1:1.25 to about 1:5.

4. The apparatus of claim 1 wherein each of said speakers rotates about an axis formed by said first and second arms of each of said connectors.

5. The apparatus of claim 4 wherein each of said speakers is designed to rotate about said axes during said first music listening mode at angles from about 0 degrees to about 100 degrees.

6. The apparatus of claim 4 wherein each of said speakers is designed to rotate about said axes during said first music listening mode at angles from about 0 degrees to about 30 degrees.

7. The apparatus of claim 4 wherein each of said speakers is designed to rotate about said axes during said second music playing mode at angles from about 20 degrees to greater than 180 degrees.

8. The apparatus of claim 4 wherein said speakers are designed to rotate about said axes during said second music playing mode at angles from about 30 degrees to about 180 degrees.

9. The apparatus of claim 1 wherein said headband is generally situated over a user's head and each of said audio output elements of each of said speakers generally faces the user's ears during said first music listening mode.

10. The apparatus of claim 1 wherein said apparatus is situated around a user's neck and both of said speakers are designed to be rotated and allow each of said audio output elements of each of said speakers to generally face away from the user during said second music playing mode.

11. The apparatus of claim 1 wherein said apparatus is set on a surface and said headband is generally parallel to the surface and said speakers are designed to be rotated about said first and second arms of each of said connectors to allow said audio output elements of each of said speaker to generally face away from the surface during said second music playing mode.

12. The apparatus of claim 11 wherein said length of said second arm relative to said first arm creates an angle between the surface and at least one speaker, said angle is greater than 1 degree and less than 90 degrees.

13. The apparatus of claim 11 wherein said length of said second arm relative to said first arm creates an angle between the surface and at least one speaker, said angle is from about 10 degrees to about 80 degrees.

14. The apparatus of claim 1 wherein each of said connectors comprises a third arm rotatably attached to opposing ends of said headband.

15. The apparatus of claim 1 further comprising a safety interlocking device which is designed to limit the volume output of said speakers in said first listening mode and increases the volume output of said speakers during said second music playing mode.

16. The apparatus of claim 1 wherein said speakers lock into place during said second music playing mode.

17. The apparatus of claim 1 further comprising at least two ear cushions, each of said cushions being attached to at least a portion of said audio output element.

18. The apparatus of claim 1 further comprising at least one amplifier, said amplifier is connected to a portion of at least one of said speakers.

19. The apparatus of claim 18 further comprising at least one switching mechanism, said switching mechanism is activated by rotating each of said speakers from said music listening mode to said second music playing mode, said rotation of said speakers activates said amplifier.

21. The apparatus of claim 18 further comprising at least one switching mechanism, said switching mechanism is activated by rotating one of said speakers from said music playing mode to said second music listening mode, said rotation of one of said speakers deactivates said amplifier.

21. The apparatus of claim 1 wherein at least one of said compartments of said speakers provides for storage of a power source.

22. The apparatus of claim 1 wherein said headband provides for storage of a power source.

23. The apparatus of claim 1 further comprises at least one power source, said power source is a battery.

24. The apparatus of claim 1 further comprises an on and off mechanism.

25. The apparatus of claim 1 further comprising volume control mechanism, said volume control mechanism controls audio output volume of said speakers.

26. The apparatus of claim 1 further comprising a cable and an adaptor.

27. The apparatus of claim 1 wherein said headband is generally U shaped.

28. The apparatus of claim 1 further comprising a wireless receiver designed to accept audio signals from an external source.

29. A music playing and listening apparatus comprising:
a headband having opposing ends;
at least two connectors, each of said connectors having at least two arms, a first arm being shorter than a second arm;
at least two speakers, each of said speakers having opposing sides and comprising an audio output element on a first side and a compartment on a second side, said first and second arms of each of said connectors being pivotally attached to a portion of each of said speakers to thereby allow rotation of said speakers, each of said audio output elements of each of said speakers generally face one another during a first music listening mode, each of said speakers is designed to be rotated to thereby allow each of said audio output elements of each of said speakers to turn away from one another during a second music playing mode; and
a safety interlocking device designed to limit the volume output of said speakers in said first listening mode and increases the volume output of said speakers during said second music playing mode.

30. The apparatus of claim 29 wherein the length ratio of said first arm to said second arm of each of said connectors is from about 1:1.1 to about 1:10.

31. The apparatus of claim 29 wherein the length ratio of said first arm to said second arm of each of said connectors is from about 1:1.25 to about 1:5.

32. The apparatus of claim 29 wherein each of said speakers rotates about an axis formed by said first and second arms of each of said connectors, each of said speakers is designed to rotate about said axes during said first music listening mode at angles from about 0 degrees to about 100 degrees.

33. The apparatus of claim 29 wherein each of said speakers rotate about an axis formed by said first and second arms of each of said connectors, wherein each of said speakers is designed to rotate about said axes during said second music playing mode at angles from about 20 degrees to greater than 180 degrees.

34. A music playing and listening apparatus comprising:
a headband having opposing ends;
at least two connectors, each of said connectors having at least two arms, a first arm being shorter than a second arm, said first and second arms having a length ratio of from about 1:1.1 to about 1:10; and
at least two speakers, each of said speakers having opposing sides and comprising an audio output element on a first side, said first and second arms of each of said connectors being pivotally attached to a portion of each of said speakers to thereby allow rotation of said speakers, each of said audio output elements of each of said speakers generally face one another during a first music listening mode, each of said speakers is designed to be rotated to thereby allow each of said audio output elements of each of said speakers to turn away from one another during a second music playing mode.
